(19) United States
(12) Patent Application Publication
(10) Pub. No.: US 2010/0118542 A1
(43) Pub. Date: May 13, 2010

(54) Appartus for Controlling and Removing Heat from a High Intensity Discharge Lamp Assembly

(76) Inventor: Stephen B. KEEN, Elgin, TX (US)

Correspondence Address: TAYLOR RUSSELL & RUSSELL, P.C., 10601 Ranch Road 2222, STE-R12, AUSTIN, TX, 78730-1138, US

(21) Appl. No.: 12/617,573

(22) Filed: Nov. 12, 2009

Related U.S. Application Data
(60) Provisional application No. 61/113,669, filed on Nov. 12, 2008.

(51) Int. Cl. F21V 29/00

(52) U.S. Cl. 362/294; 362/373

(57) ABSTRACT

An apparatus for use with high intensity discharge lamps is provided that controls and removes heat from high intensity discharge lamp assemblies used in industrial lighting applications, such as large retail stores, warehouses and facilities for growing plants indoors. It provides an improved method for water cooling a high intensity discharge lamp assembly by removing significantly more heat than traditional and most commonly used air cooling methods. Application flexibility is provided to match desired application-specific requirements with various apparatus configurations.

This application claims benefit of U. S. Provisional Application No. 61/113,669, filed on Nov. 12, 2008.

### BACKGROUND

The present invention relates generally to lighting systems that are used in industrial lighting applications, such as large retail stores, warehouses and facilities for growing plants indoors. More particularly, it provides an improved method for water cooling a high intensity discharge (HID) lamp assembly by removing significantly more heat than traditional and most commonly used air cooling methods. It does not suffer from the limitations of currently used water cooling methods and may also provide supplemental air conditioning to the lighted environment.

Indoor hydroponic and soil-based plant growing systems have become indispensable in the indoor horticultural industry. Each system includes and requires plant nutrient media and containers, climate control, lamping, and hydration. Large plants and those native to high-sunlight environments typically require high intensity lamps for optimal growing conditions, so sufficient light is a major factor in indoor and greenhouse gardening. Typically, very strong lamps (1000 watts) are necessary. Further, in industrial lighting, the wattage is typically much lower but in many cases several hundred lamps are used in a single building to adequately illuminate the indoor space for consumers and employees. In most cases a lamp reflector is used to ensure that all available light is being reflected down onto the plants being grown or the merchandise below. These lamps do an adequate job from a lighting or sunlight replication standpoint, but they also produce significant heat that can either damage the plants that are growing or create a very uncomfortable shopping and working environment for consumers and employees. For this reason, significant effort and expense are put into cooling systems, usually including air conditioning in industrial applications and a combination of air conditioning, fans, and water cooling methods for indoor gardening applications. Facility-wide cooling systems may be used, but such systems are very costly and result in significant expense in both industrial and indoor gardening applications. If operated in an indoor gardening application, these systems may result in temperatures below optimum in the areas around plants under low intensity lighting housed in the same facility. Further, traditional air conditioning is extremely inefficient when used in such applications as only a small portion the energy consumed actually translates to cooling temperatures.

It is well-known that the intensity of a light source, such as a HID lamp, on any given surface is reduced by the square of the distance from the light source. The closer light sources are to objects being illuminated, the hotter the objects become due to both thermal and illuminating energy from the light sources. Sufficient cooling applied directly to the light sources, such as HID lamps, to reduce thermal irradiation allows the light sources to be moved closer to the illuminated objects. In indoor gardening applications, this allows more lights to be placed within smaller areas, resulting in greater illumination and resulting greater crop output per square foot of illuminated area. In both indoor gardening and industrial applications, the HID lamps can be moved closer to their subjects, resulting in lower power requirements and resulting energy savings. Since in industrial lighting applications, ballasts are connected to HID lamp assemblies, the invention allows for cooling of both the ballast and the HID lamp at the same time.

Some existing water-cooled solutions may address some of the problems associated with heat removal from HID lamp housings. However, they also have several problems of their own, including high cost, the requirement for passing light through a cooling liquid of high optical clarity, and the possibility of a cooling liquid making contact with electrical components in the event of a leak or excessive condensation.

### SUMMARY

The present invention provides improved apparatus for cooling and handling heat produced by HID lamps. Its primary purpose is to improve the efficiency of these lamps and reduce energy consumption associated with the use of these lamps by allowing for a mixture of air and water cooling the environment surrounding HID lamps, without the significant expense and other drawbacks associated with water cooling HID lamps themselves.

The invention consists of 2 major parts, an air to liquid heat exchanger and heat exchanger housing with duct flanges. The heat exchanger may be comprised of materials such as aluminum, copper and stainless steel. In a preferred embodiment, it consists of an aluminum exterior with copper liquid tubing. The heat exchanger housing in both ducted and reflector-mounted applications may comprise a heavy-duty custom molded plastic structure with duct flanges. The duct flanges are typically 4 inches, 6 inches and 8 inches in diameter on the sides of the housing, having strategically placed holes for water inlet, water outlet, and condensation and emergency drain.

A salient feature of the invention is the air to liquid heat exchanger set inline with air ducting already used in most HID lamp applications for indoor gardening. In industrial applications, the air flow isn't currently captured within ducting and is instead free-flowing within the room. The invention further comprises capturing and forcing air through the heat exchanger for the purpose of cooling the HID lamp in industrial applications. The heat exchanger housing in industrial applications is built into the air capture system. Cool water or other liquids may be used as a heat transfer vehicle, including but not limited to Freon, a non-conductive cooling liquid, a non-corrosive liquid, ethylene glycol, diethylene glycol, propylene glycol, betaine, mineral oils, silicon oils and fluorocarbon oils. The cooling liquid is circulated through the heat exchanger while air blowing across an HID lamp is circulated through the heat exchanger either after blowing over the lamp, before blowing over the lamp, or both, depending on the intensity of the application and the specific cooling needs of the user.

Another feature is that the invention can also be used to provide supplemental or primary air conditioning to a given space as well as dehumidifying the space. When water or liquid running through the heat exchanger is cooler than the ambient temperature of the space, the air leaving the heat exchanger is cooler than the ambient air going in. If the water temperature is cool enough, this can even be accomplished, taking the heat produced by the HID lamp into account. Additionally, when the temperature of the liquid running through the heat exchanger is lower than the dew point temperature of the space, condensation from the air forms on the heat exchanger and connecting air lines. This condensation, which may be collected through the housing, results in dehumidification of the ambient inlet air.

An embodiment of the present invention is an apparatus for controlling and removing heat from a high intensity discharge lamp assembly, comprising the high intensity discharge lamp assembly having an ambient air inlet for acquiring air from an ambient environment and an exhaust air outlet for exhausting heated air, the high intensity discharge lamp assembly including one or more high intensity discharge lamps, a heat exchanger assembly having a heat exchanger inlet connected to the exhaust air outlet and a heat exchanger outlet connected via ducting to a duct fan for dispersing cooled air from the heat exchanger outlet to an input of the duct fan, an output of the duct fan connected to the ambient environment, means for circulating chilled cooling liquid through the heat exchanger for cooling air from the exhaust air outlet, and a temperature of the cooled air from the heat exchanger outlet being controlled by the heat exchanger. The apparatus, wherein the means for circulating chilled cooling liquid includes a pump for pumping cooling liquid from a reservoir through a cooling mechanism to the heat exchanger, and from the heat exchanger back to the reservoir. The apparatus, wherein the cooling liquid is selected from the group comprising water, Freon, a non-conductive cooling liquid, a non-corrosive liquid, ethylene glycol, diethylene glycol, propylene glycol, betaine, mineral oils, silicon oils and fluorocarbon oils. The apparatus, wherein the cooling mechanism is selected from the group consisting of a chiller, an evaporative cooler, a liquid-to-liquid cooler, a liquid-to-air cooler and a cooling pond. The apparatus, further comprising more than one heat exchangers operating in a series with the exhaust air outlet. The apparatus, further comprising more than one high intensity discharge lamp assemblies and more than one heat exchangers, wherein the exhaust outlet of each high intensity discharge lamp assembly is coupled to a heat exchanger inlet. The apparatus, wherein the heat exchanger outlet is connected to the ambient air inlet of the high intensity discharge lamp assembly and the heat exchanger inlet is open to ambient air. The apparatus, wherein an output of the duct fan is connected to the ambient air inlet of the high intensity discharge lamp assembly. The apparatus, wherein the heat exchanger is mounted within the high intensity discharge lamp assembly. The apparatus, wherein the high intensity discharge lamp assembly comprises an external metal casing, including a high intensity discharge bulb mounted within a parabolic reflector, a ballast for the high intensity discharge lamp, and the heat exchanger and the duct fan for ducting cooled air from the external metal casing.

### BRIEF DESCRIPTION OF THE DRAWINGS

These and other features, aspects and advantages of the present invention will become better understood with regard to the following description, appended claims, and accompanying drawings wherein:

FIG. 1 is perspective view of a heat exchanger;

FIG. 2 is top view of a heat exchanger;

FIG. 3 is a perspective view of a ducted housing;

FIG. 4 is another perspective view of a heat exchanger;

FIG. 5 is a perspective view of a heat exchanger placed inside a ducted plastic housing;

FIG. 6 is a diagram of a single lamp assembly, single heat exchanger with separate fan set-up in an indoor gardening application;

FIG. 7 is a diagram of a single lamp assembly, multiple heat exchangers with separate fan set-up in an indoor gardening application;

FIG. 8 is a diagram of a multiple lamp assemblies, multiple heat exchangers with separate fan set-up in an indoor gardening application;

FIG. 9 is a diagram of a single lamp, captured air-flow, built-in fan set up in an industrial lamping application;

FIG. 10 is a diagram of multiple configuration possibilities in indoor gardening applications;

FIG. 11 is an exploded view from the side of the heat exchanger placed inside a ducted housing; and

FIG. 12 is an exploded view cross section of the heat exchanger placed inside the ducted housing.

### DETAILED DESCRIPTION OF THE DRAWINGS

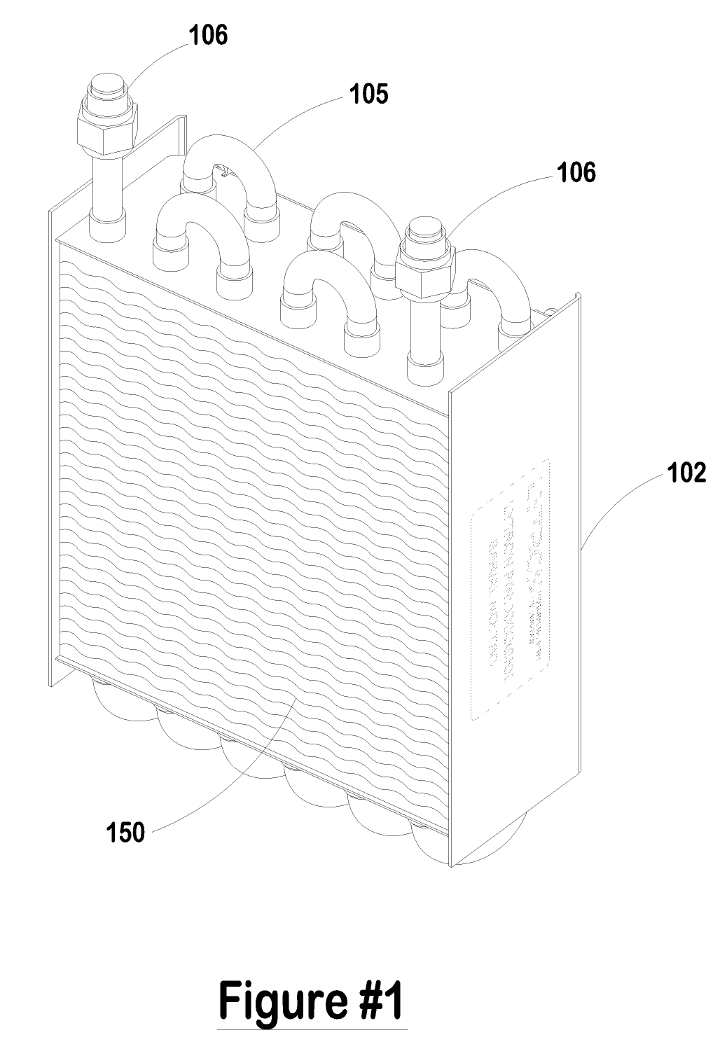

Referring to FIG. 1, FIG. 1 is perspective view of a heat exchanger from the front of the heat exchanger 102. The invention includes water inlets 106 and outlets 106 that can be used either direction, copper or other metal liquid passage 105, and the main body of a heat exchanger 102 including a finned interior 150 for maximum heat transfer. The heat exchanger 102 can be either round-tube or flat-tube in design, where a round tube sign is illustrated. The water inlet/outlet connections 106 can be hose barbs, soldered copper, compression fittings, quick disconnect fittings, hose clamps, or other methods of connection as applicable.

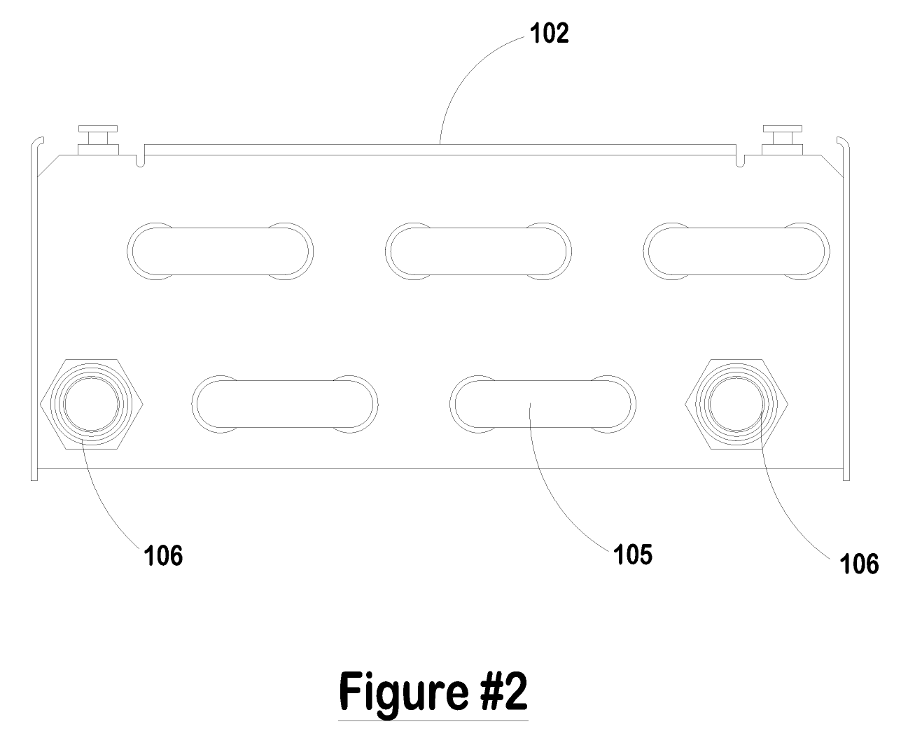

Referring to FIG. 2, FIG. 2 shows top view of a heat exchanger 102 which may be mounted in either direction, with inlets/outlets 106 upward or downward facing.

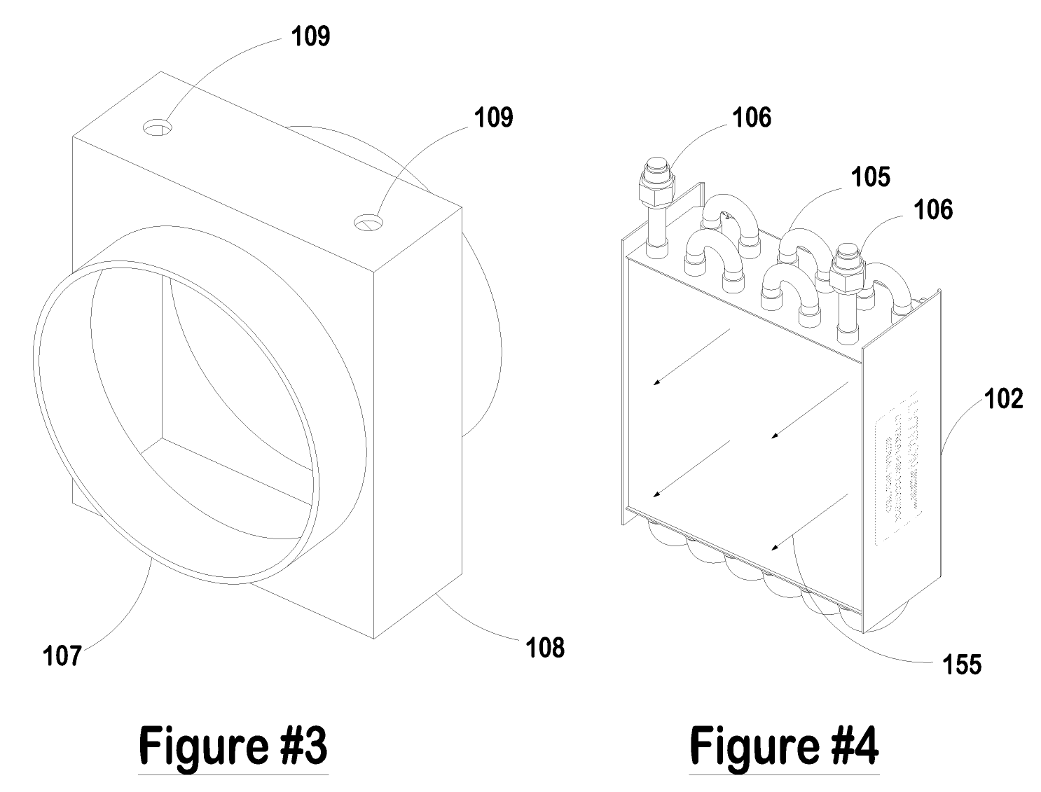

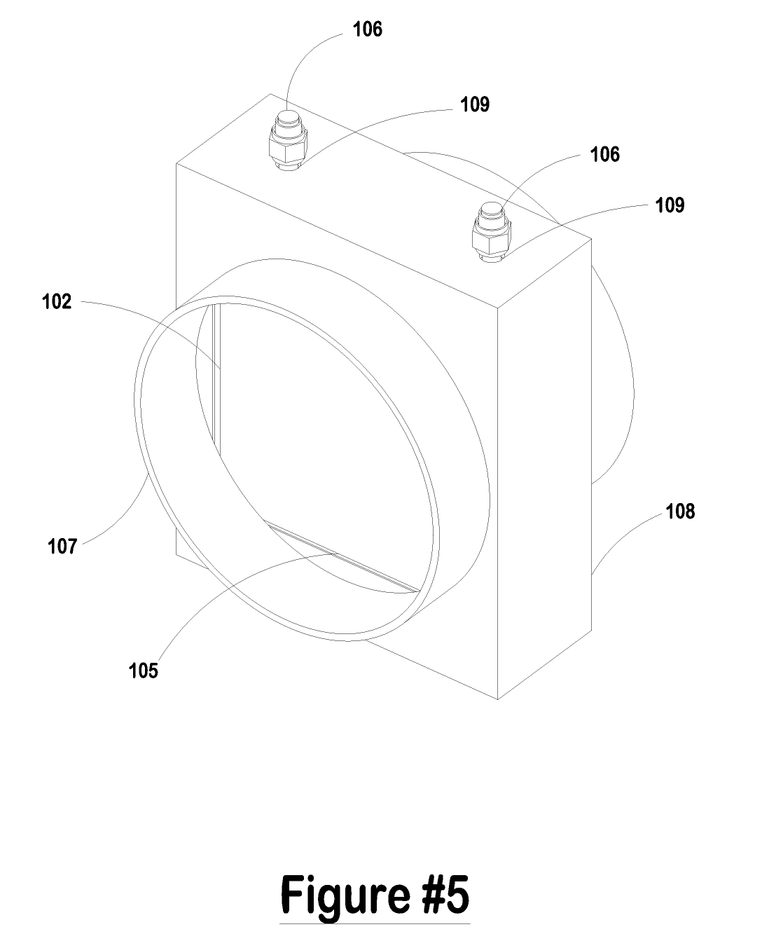

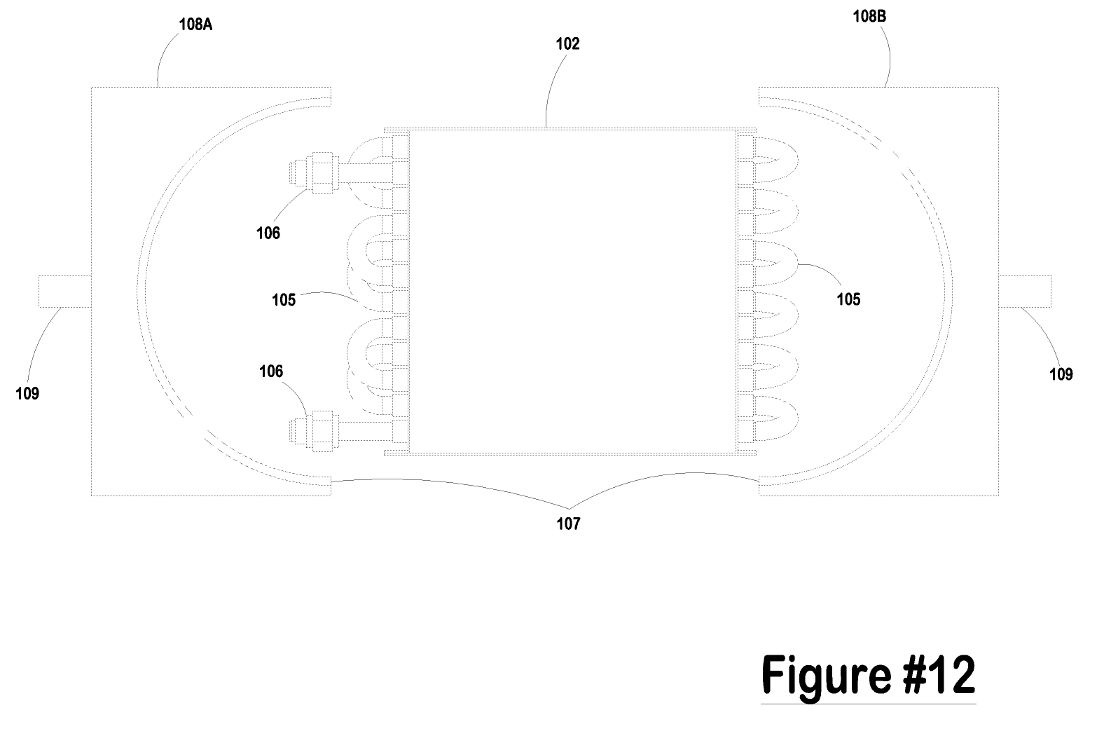

Referring to FIG. 3 and FIG. 4, FIG. 3 is a perspective view of a ducted housing 108 and FIG. 4 is another perspective view of a heat exchanger 102 illustrating the direction of airflow 155 through the heat exchanger 102. The ducted housing 108 is made in two parts (as shown in FIG. 11 and FIG. 12) and fits around the heat exchanger 102. In a preferred embodiment, the housing 108 is fabricated from two molded plastic pieces. The liquid inlets/outlets 106 in the heat exchanger 102 fit in the molded holes 109 in the housing. The duct flanges 107 built in to the housing allow for mounting to air ducting or directly to a reflector assembly, and creates passages for air to flow over the main body of the heat exchanger 102.

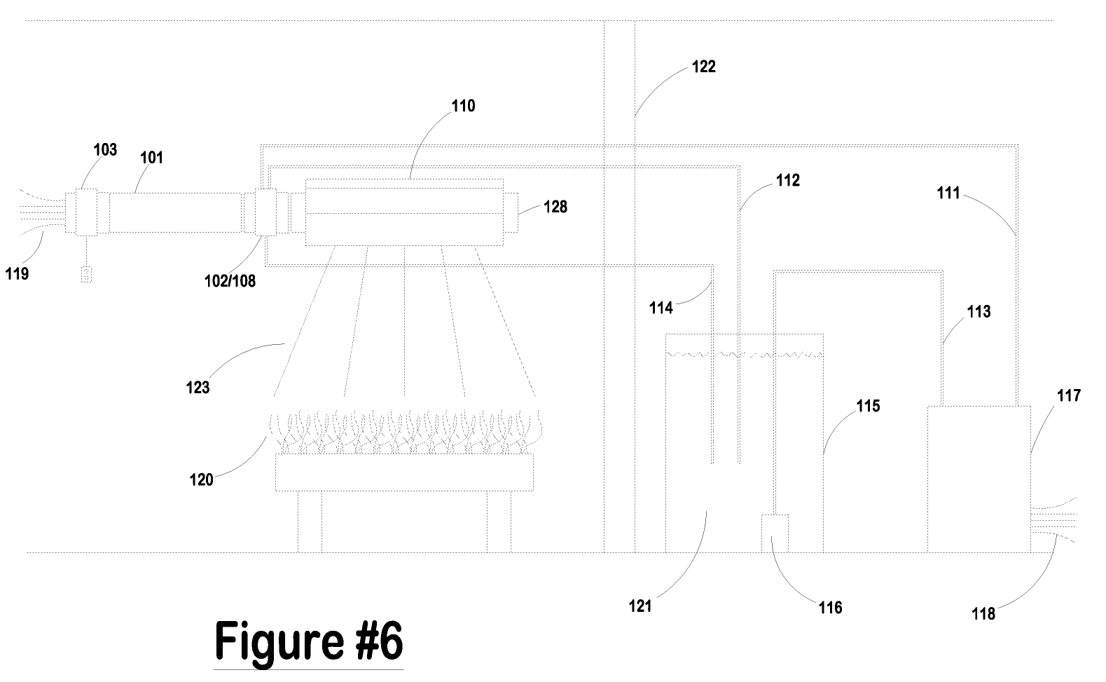

Referring to FIG. 5, FIG. 5 is a perspective view of a heat exchanger 102 placed inside a ducted housing 108. The liquid inlets/outlets 106 in the heat exchanger fit in the molded holes 109 in the housing 108. The duct flanges 107 built in to the housing 108 allow for mounting to air ducting or directly to a reflector and create passages for air to flow over the main body of the heat exchanger 102. The molded holes in the housing 108 are present on both halves of the housing 108. The holes' presence on both sides of the housing 108 allows the heat exchanger 102 to be mounted in either direction, and for the extra holes to be used to drain condensation.

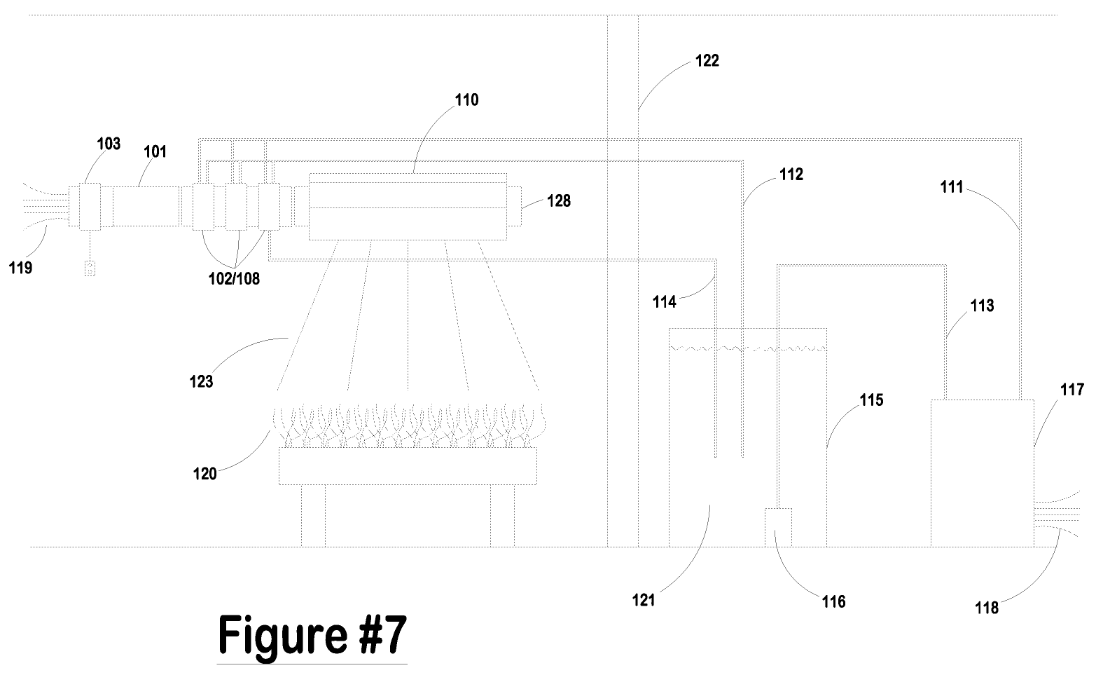

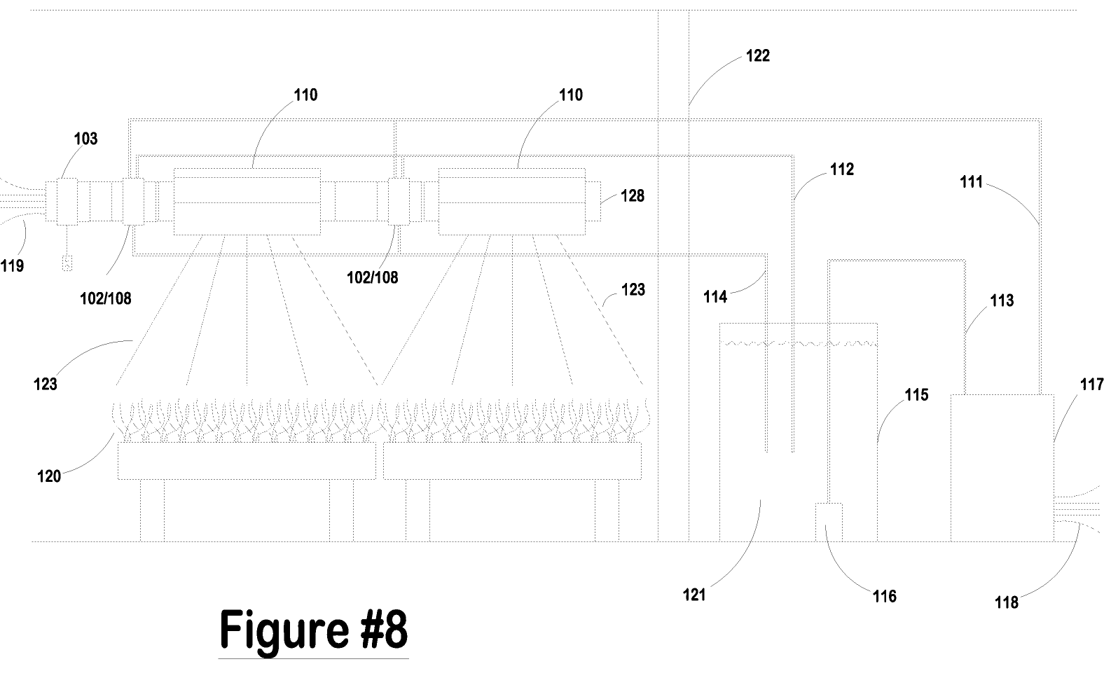

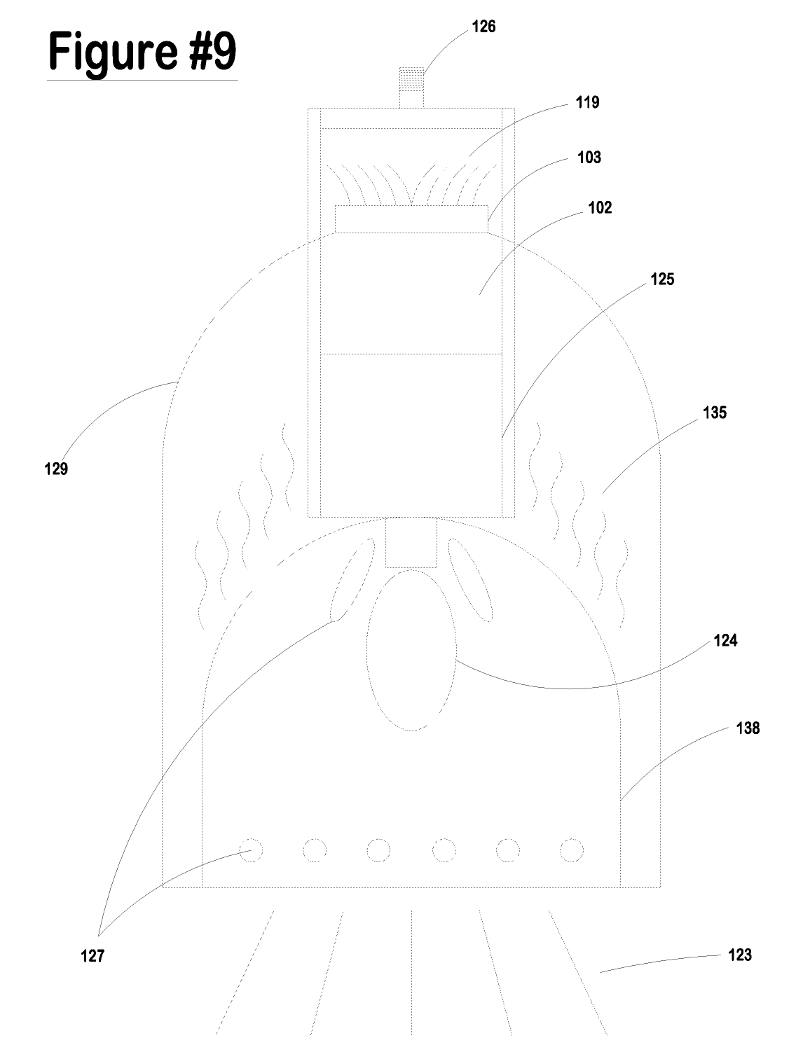

Referring to FIGS. 6-8, FIG. 6 is a diagram of a single lamp assembly, single heat exchanger with separate fan set-up in an indoor gardening application, FIG. 7 is a diagram of a single lamp assembly, multiple heat exchangers with separate fan set-up in an indoor gardening application, and FIG. 8 is a diagram of a multiple lamp assemblies, multiple heat exchangers with separate fan set-up in an indoor gardening application. In FIG. 6, the heat exchanger 102 and housing 108 are mounted directly to a HID lamp assembly 110, with ducting 101 attaching the heat exchanger to a duct fan 103 on the other side. Light 123 exits the bottom of the HID lamp assembly 110 onto the plants 120 below. A reservoir 115 filled with cooling liquid 121, which is cooled using a chiller 117 is located on the other side, both of which are isolated from the HID lamp assembly by a wall 122 outside or in another room. The cooling liquid 121 is moved from the reservoir 115 using a pump 116, through the chiller cooler liquid line 113, to the chiller 117 where it is cooled to user specified temperature. From the chiller 117, it is continuously pumped through the heat exchanger cooler liquid line 111, through the heat exchanger 102, and back into the reservoir 115 through the reservoir cooler liquid line 114. Condensation line 112 provides for condensate to be returned to the reservoir 115. Ambient air 128 is drawn into an ambient air inlet of the HID lamp assembly 110 by a fan 103, through an exhaust air outlet of the HID lamp assembly 110, through a heat exchanger inlet, cooled by the heat exchanger 102, and out the heat exchanger outlet. The cooled air 119 is then ducted 101 to the duct fan 103 and exhausted to the ambient environment. Heat 118 is expelled from the chiller 117 in a separate environment. In FIG. 7, the same configuration is used as in FIG. 6 with several heat exchangers 102 contained within housings 108 mounted in series. This allows greater liquid 121 surface area to make contact with the heated air from the HID lamp assembly 110 resulting in cooler air 119 being exhausted into the ambient environment than that released in the single heat exchanger set up of FIG. 6. In FIG. 8, the exact same set up is used with several HID lamp assemblies 110 set up in series with heat exchangers 102 in between. The cooling liquid 121 is brought to the heat exchangers through a cooling liquid line 111 in a manifold type system, allowing the coolest cooling liquid to be present after the air ambient 128 exits each HID lamp assembly 110. Air 128 is warmed by a HID lamp assembly 110, cooled by a heat exchanger 102, warmed by a HID lamp assembly 110, cooled by a heat exchanger 102, etc., until cooled air 119 exits through the fan 103 at the end. It's important to note that the heat exchanger 102 and fan 103 can be mounted on the same side or opposite sides of the HID lamp assembly 110, and air can either be drawn in or pushed out of the HID lamp assemblies 110. It is up to the user to decide which works best for his or her application and as long as heated air is being drawn over the heat exchanger 102, all methods will work. The heat exchanger 102 could also be mounted inside the HID lamp assembly 110, if desired. Further, the chiller 117 is not the only method of cooling the liquid being drawn through the heat exchanger 102. Other methods of cooling include but are not limited to evaporative cooling, liquid to liquid or liquid to air heat exchangers or the use of a very large body of water with no cooling method (e.g., a cooling pond).

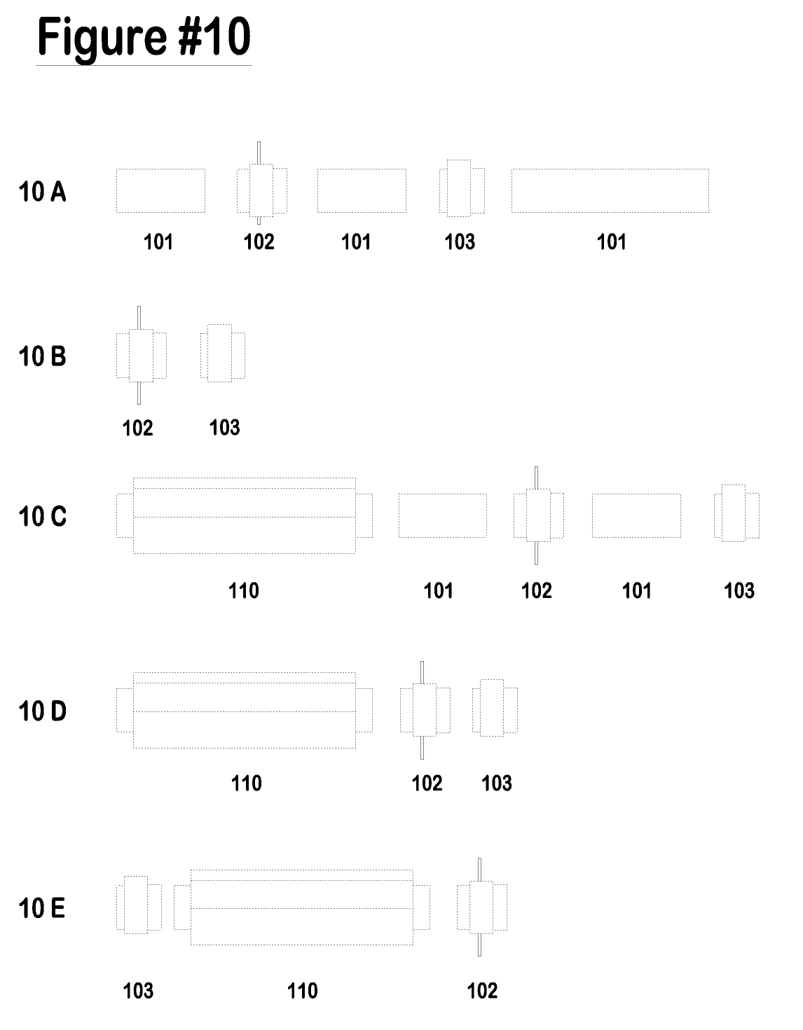

Referring to FIG. 9, FIG. 9 is a diagram of a single lamp, captured air-flow, built-in fan set up in an industrial lamping application. A HID bulb 124 is housed within an interior parabolic reflector 138, which is in turn surrounded by an external metal casing 129 similarly shaped so as to capture heated air 135 drawn in through air vents 127 via an internally located fan 103. The air flows over the bulb 124 and ballast 125, drawing heat from both sources through the heat exchanger 102, where cooled air 119 is expelled through the fan 103. The fixture is threaded at the top for mounting 126 and light 123 is reflected down through the parabolic reflector 110.

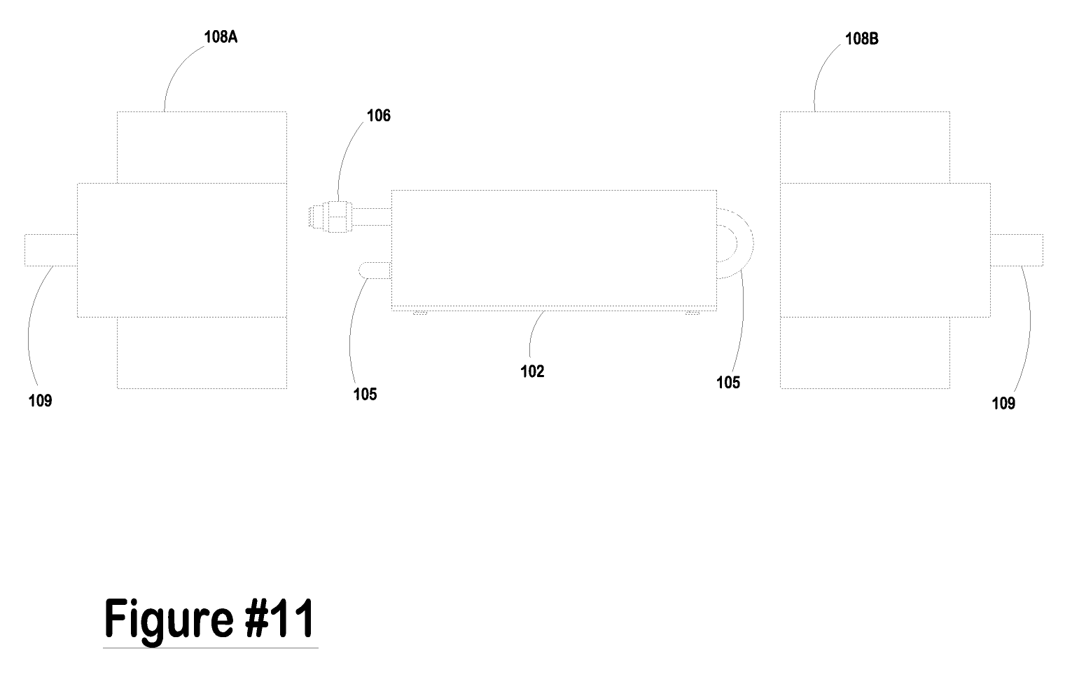

Referring to FIG. 10, FIG. 10 is a diagram of multiple configuration possibilities in indoor gardening application. Each subset illustrated in FIGS. 10A, 10B, 10C, 10D, and 10E are exploded views illustrating the various ways the heat exchanger, fan, reflector, and optional ducting can be configured in an indoor gardening application. FIG. 10A illustrates the heat exchanger 102 hooked up to ducting 101 with the fan 103 drawing or forcing air through the heat exchanger 102. FIG. 10B illustrates the fan 103 hooked directly to the heat exchanger 102 with no ducting. FIG. 10C illustrates the reflector 104 hooked to ducting 101, hooked to the heat exchanger 102, then hooked to the fan 103 through more ducting 101, both on the same side of the HID lamp assembly 110. FIG. 10D illustrates a HID lamp assembly 110, heat exchanger 102 and fan 103 connected without ducting, both on the same side of the HID lamp assembly 110, and FIG. 10E illustrates the heat exchanger 102 and fan 103 hooked to either side of the HID lamp assembly 110 with no ducting.

Referring to FIG. 11, FIG. 11 is an exploded view from the side of the heat exchanger 102 placed inside a ducted housing 108. The heat exchanger casing 108 is made in two mirrored molded pieces 108A and 108B. The two pieces fit together around the heat exchanger 102. Water or other cooling liquid is introduced through the water in/out/condensation drain 109, into the nozzle 106 and is circulated through the radiator tubing 105.

Referring to FIG. 12, FIG. 12 is an exploded view cross section of the heat exchanger 102 placed inside the ducted housing. This figure illustrates a front-side view of that which is illustrated from the side in FIG. 11. Air is introduced through the ducting flanges 107 located in the front and back of the heat exchanger casing 108.

Although the present invention has been described in detail with reference to certain preferred embodiments, it should be apparent that modifications and adaptations to those embodiments might occur to persons skilled in the art without departing from the spirit and scope of the present invention.

1. An apparatus for controlling and removing heat from a high intensity discharge lamp assembly, comprising:
the high intensity discharge lamp assembly having an ambient air inlet for acquiring air from an ambient environment and an exhaust air outlet for exhausting heated air, the high intensity discharge lamp assembly including one or more high intensity discharge lamps;
a heat exchanger assembly having a heat exchanger inlet connected to the exhaust air outlet and a heat exchanger outlet connected via ducting to a duct fan for dispersing cooled air from the heat exchanger outlet to an input of the duct fan, an output of the duct fan connected to the ambient environment;
means for circulating chilled cooling liquid through the heat exchanger for cooling air from the exhaust air outlet; and
a temperature of the cooled air from the heat exchanger outlet being controlled by the heat exchanger.

2. The apparatus of claim 1, wherein the means for circulating chilled cooling liquid includes a pump for pumping cooling liquid from a reservoir through a cooling mechanism to the heat exchanger, and from the heat exchanger back to the reservoir.

3. The apparatus of claim 2 wherein the cooling liquid is selected from the group comprising water, Freon, a non-conductive cooling liquid, a non-corrosive liquid, ethylene glycol, diethylene glycol, propylene glycol, betaine, mineral oils, silicon oils and fluorocarbon oils.

4. The apparatus of claim 2, wherein the cooling mechanism is selected from the group consisting of a chiller, an evaporative cooler, a liquid-to-liquid cooler, a liquid-to-air cooler and a cooling pond.

5. The apparatus of claim 1, further comprising more than one heat exchangers operating in a series with the exhaust air outlet.

6. The apparatus of claim 1, further comprising more than one high intensity discharge lamp assemblies and more than one heat exchangers, wherein the exhaust outlet of each high intensity discharge lamp assembly is coupled to a heat exchanger inlet.

7. The apparatus of claim 1, wherein the heat exchanger outlet is connected to the ambient air inlet of the high intensity discharge lamp assembly and the heat exchanger inlet is open to ambient air.

8. The apparatus of claim 1, wherein an output of the duct fan is connected to the ambient air inlet of the high intensity discharge lamp assembly.

9. The apparatus of claim 1, wherein the heat exchanger is mounted within the high intensity discharge lamp assembly.

10. The apparatus of FIG. 1, wherein the high intensity discharge lamp assembly comprises an external metal casing, including:
a high intensity discharge bulb mounted within a parabolic reflector;
a ballast for the high intensity discharge lamp;
the heat exchanger and the duct fan for ducting cooled air from the external metal casing.
